(19) United States
(12) Patent Application Publication
(10) Pub. No.: US 2017/0126042 A1
(43) Pub. Date: May 4, 2017

(54) WIRING CONCENTRATION APPARATUS WITH REMOVABLE POWER SOURCE

(71) Applicants: LIANG-CHIH CHEN, TAIPEI CITY (TW); POWERSOLUTIONS TECHNOLOGY CORP., TAIPEI CITY (TW)

(72) Inventor: LIANG-CHIH CHEN, TAIPEI CITY (TW)

(21) Appl. No.: 14/926,110

(22) Filed: Oct. 29, 2015

(51) Int. Cl. H02J 7/00

(52) U.S. Cl. CPC H02J 7/0054; H02J 7/007; H02J 2007/0062

(57) ABSTRACT

A wiring concentration apparatus with a removable power source is introduced. The wiring concentration apparatus includes a wiring concentration portion having a first connection end and a power portion having a second connection end corresponding to the first connection end. The wiring concentration portion and the power portion connect with and operate in conjunction with each other. Ports of the wiring concentration portion and ports of the power portion are regarded by each other as expansion ports. The ports of the wiring concentration portion enable external apparatuses to be charged. The ports of the power portion enable the external apparatuses to exchange data with a host apparatus. The wiring concentration portion and the power portion are separable from each other such that a user carries only one of them as needed, thereby achieving enhanced portability.

### FIELD OF TECHNOLOGY

The present invention relates to wiring concentration apparatus and more particularly to a wiring concentration apparatus equipped with a removable power source and capable of adjusting the number of connection ends.

### BACKGROUND

Wiring concentrators (commonly known as “hubs”) and mobile power sources are popular electronic products. A wiring concentrator enables multiple external apparatus to connect with a host apparatus and exchange data with the host apparatus. A mobile power source is a portable charger for charging cellular phones, tablets, and any other external apparatus at any time and any place.

However, conventional wiring concentrators and mobile power sources have a limited number of ports for connection with external port apparatuses. If the external apparatuses outnumber the ports of the wiring concentrators or the ports of the mobile power sources, some of the external apparatuses cannot exchange data and/or cannot be charged. If multiple ports are disposed at a single wiring concentrator or a single mobile power source, the wiring concentrator or mobile power source will be bulky and thus not portable.

Accordingly, it is imperative to provide a wiring concentration apparatus with a removable power source to overcome the above drawbacks of the prior art.

### SUMMARY

It is an objective of the present invention to provide a wiring concentration apparatus with an adjustable number of connection ends.

In order to achieve the above and other objectives, the present invention provides a wiring concentration apparatus with a removable power source, adapted to effect at least one of charging an external apparatus and exchanging data with a host apparatus, the wiring concentration apparatus comprising: a wiring concentration portion having a first processor, a plurality of first ports, a first connection end and a host port, wherein the first ports exchange data with the external apparatus connected thereto and exchange data with a host apparatus connected to the host port through the first processor; and a power portion having a second processor, a plurality of second ports, a second connection end corresponding to the first connection end, and an internal battery, wherein the second ports effectuate a charging process performed on the external apparatus connected to the second ports with a power derived from the internal battery through the second processor, wherein, when the wiring concentration portion and the power portion are connected through the first connection end and the second connection end, first ports of the wiring concentration portion function as the second ports extended from the power portion, and second ports of the power portion function as the first ports extended from the wiring concentration portion.

In an embodiment of the present invention, first ports of the wiring concentration portion comprise identical or different ports.

In an embodiment of the present invention, first ports of the wiring concentration portion has ports complying with a USB type-c protocol.

In an embodiment of the present invention, second ports of the power portion comprise identical or different ports.

In an embodiment of the present invention, second ports of the power portion has ports complying with a USB type-c protocol.

In an embodiment of the present invention, the wiring concentration portion further comprises a first external power input end connected to the first processor to receive an external power and supply the external power to at least one of the external apparatus and the internal battery.

In an embodiment of the present invention, the first processor of the wiring concentration portion chooses one of a power supplied by the host apparatus, the external power, and a power supplied by the power portion in accordance with a predetermined power priority sequence and supplies the selected power to at least one of the external apparatus and the internal battery.

In an embodiment of the present invention, the power portion further comprises a second external power input end connected to the second processor to receive the external power and supply the external power to at least one of the external apparatus and the internal battery.

In an embodiment of the present invention, the second processor of the power portion chooses one of the external power and a power supplied by the internal battery in accordance with a predetermined power priority sequence and supplies the selected power to at least one of the external apparatus and the wiring concentration portion.

In an embodiment of the present invention, the wiring concentration portion further comprises a first indicating module connected to the first processor to display an operating status of the wiring concentration portion.

In an embodiment of the present invention, the power portion further comprises a second indicating module connected to the second processor to display an operating status of the power portion.

In an embodiment of the present invention, the internal battery of the power portion is a rechargeable battery.

In an embodiment of the present invention, the power portion further comprises a third connection end connected to the second connection end of another power portion.

Accordingly, the present invention provides a wiring concentration apparatus with a removable power source is provided. The wiring concentration apparatus includes a wiring concentration portion having a first connection end and a power portion having a second connection end corresponding to the first connection end. The wiring concentration portion and the power portion connect with and operate in conjunction with each other. Ports of the wiring concentration portion and ports of the power portion are regarded by each other as expansion ports. The ports of the wiring concentration portion enable external apparatuses to be charged. The ports of the power portion enable the external apparatuses to exchange data with a host apparatus. The wiring concentration portion and the power portion are separable from each other such that a user carries only one of them as needed, thereby achieving enhanced portability.

### BRIEF DESCRIPTION

Objectives, features, and advantages of the present invention are hereunder illustrated with specific embodiments in conjunction with the accompanying drawings, in which:

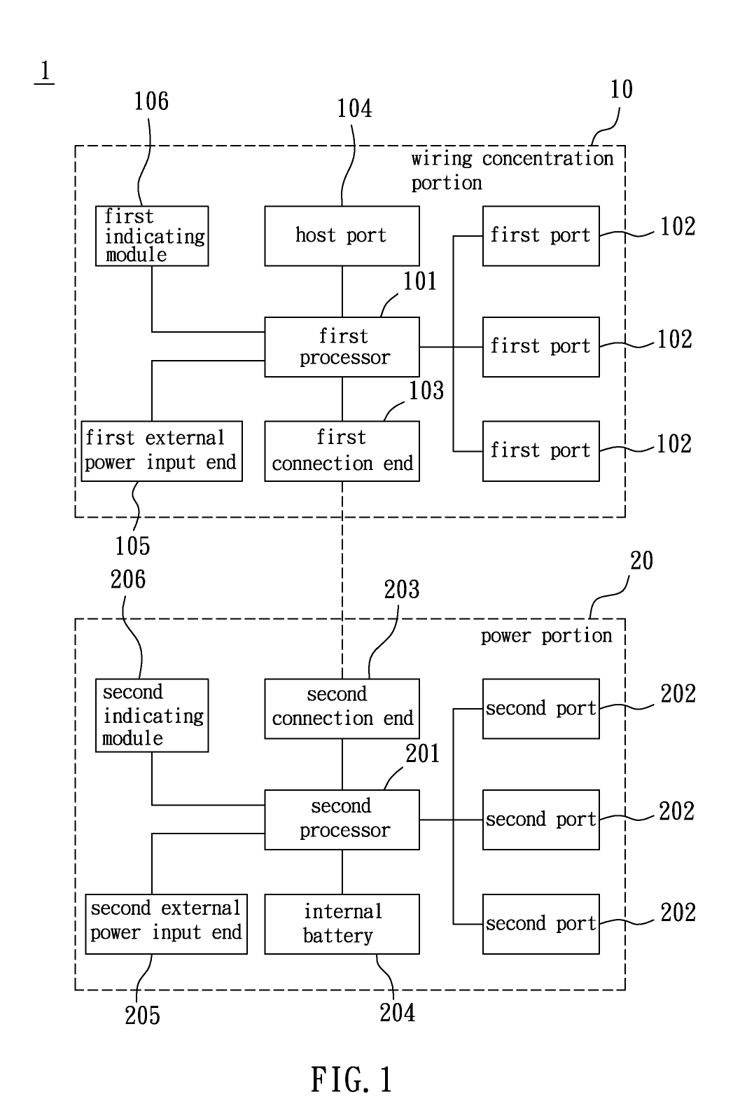

FIG. 1 is a function block diagram of a wiring concentration apparatus with a removable power source according to the present invention; and

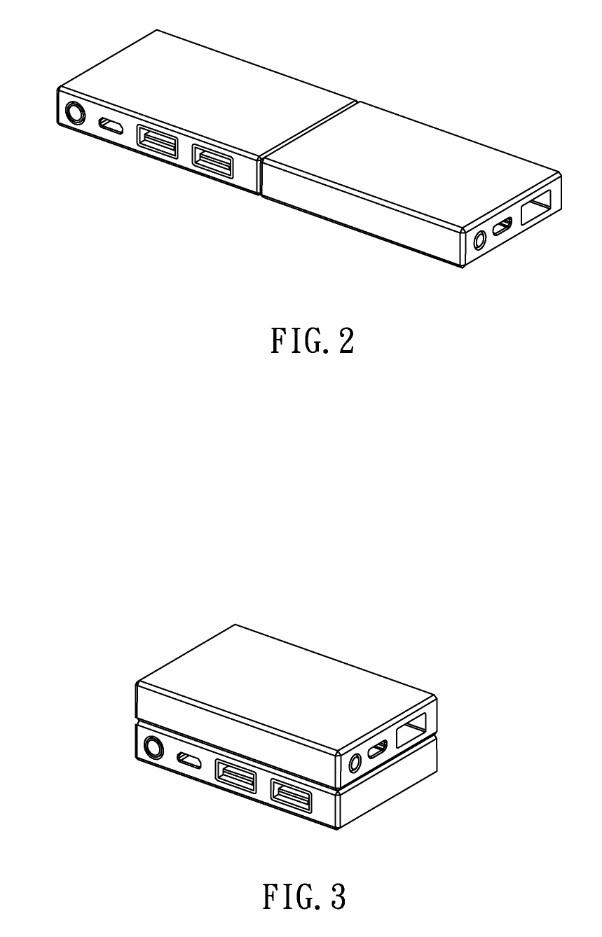

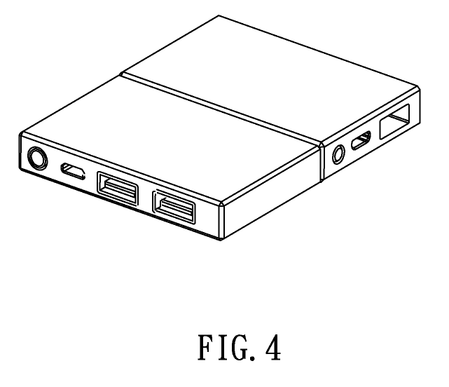

FIG. 2 through FIG. 4 are schematic views of a wiring concentration portion and a power portion which are coupled together according to various embodiments of the present invention.

### DETAILED DESCRIPTION

Referring to FIG. 1, there is shown a function block diagram of a wiring concentration apparatus 1 with a removable power source according to the present invention. The wiring concentration apparatus 1 has a wiring concentration portion 10 and a power portion 20.

The wiring concentration portion 10 has a first processor 101, a plurality of first ports 102, a first connection end 103 and a host port 104. The first ports 102, the first connection end 103 and the host port 104 are each connected to the first processor 101.

The first ports 102 has pins for transmitting power and data and connecting with an external apparatus (not shown). The first processor 101 is for use in data processing such that the wiring concentration portion 10 serves as a data transmission relay apparatus whereby the external apparatus exchanges data with a host apparatus (not shown) connected to the host port 104. The first ports 102 are either identical or different. For instance, the first ports 102 are USB Type-C ports or comprise the same or different types of ports for connecting with external apparatuses with different transmission interfaces. The host port 104 complies with transmission specifications in accordance with the transmission specifications of the host apparatus and is usually a USB port. Moreover, in this embodiment, the first ports 101 are in the number of three; however, the quantity and type of the first ports are subject to changes as needed.

The first processor 101 controls the operation of the wiring concentration portion 10, such as data processing and power delivery. The first connection end 103 enables data and power to be transmitted between the wiring concentration portion 10 and the power portion 20 and is further described later.

The power portion 20 has a second processor 201, a plurality of second ports 202, a second connection end 203 corresponding to the first connection end 103, and an internal battery 204. The second ports 202, the second connection end 203 and the internal battery 204 are each connected to the second processor 201.

The second ports 102 has pins for transmitting power and data, connecting with the external apparatus, and receiving power from the internal battery 204 through the second processor 201 to thereby charge the external apparatus. Like the first ports 102, the second ports 202 are either identical or different. For instance, the second ports 202 are USB T e-C ports or comprise the same or different types of ports for connecting with external apparatuses with different transmission interfaces. The internal battery 204 is a rechargeable battery, such as NiCd battery, NiMH battery, Li battery and Li-polymer battery.

The second processor 201 controls the operation of the power portion 20, such as data processing and power delivery. The second connection end 203 of the power portion 20 corresponds to the first connection end 103 of the wiring concentration portion 10. The connection ends 103, 203 have pins for transmitting power and data, such as GND, HS, SS, D+, D−, CC1, CC2 which comply with USB transmission interfaces, so for the wiring concentration portion 10 to transmit power and exchange data with the power portion 20. Furthermore, a connection mechanism for use with the connection ends 103, 203 is based on techniques related to engagement, magnetic attraction, or any means of connection well-known to persons skilled in the art.

In an embodiment, the wiring concentration portion 10 has a first external power input end 105 for receiving external power (such as the electrical power supplied by an electric utility). The first external power input end 105 connects with the first processor 101. Once the first external power input end 105 starts to receive the external power, the external power is converted, under the control of the first processor 101, into an appropriate voltage or current for use by the external apparatus connected to the wiring concentration portion 10, thereby supplying power to the external apparatus in operation and/or charging the internal battery 204 of the power portion 20. The power portion 20 comprises a second external power input end 205. Like the first external power input end 105, the second external power input end 205 connects with the second processor 201 to receive external power and/or charge the internal battery 204 through the external apparatus.

In an embodiment, the wiring concentration portion 10 further comprises a first indicating module 106 connected to the first processor 101 and adapted to display the operating status of the wiring concentration portion 10, such that users gain insight to the operation of the wiring concentration portion 10. The first indicating module 106 is a LED lamp which flashes or emits light of different colors to indicate that data transmission is underway. The power portion 20 further comprises a second indicating module 206 connected to the second processor 201. Like the first indicating module 106, the second indicating module 206 displays the operating status of the power portion 20, such as the remaining power level of the internal battery 204 of the power portion 20.

When the wiring concentration portion 10 has not yet connected with the power portion 20, both the wiring concentration portion 10 and the power portion 20 are operating on their own, that is, the wiring concentration portion 10 can function as a wiring concentrator independently, whereas the power portion 20 can function as a mobile power source independently. When the wiring concentration portion 10 connects with the power portion 20, the first ports 102 of the wiring concentration portion 10 are deemed the second ports 202 extended from the power portion 20 through the power and data exchange taking place between the first connection end 103 and the second connection end 203. Hence, the otherwise self-contained power portion 20 has only three second connection ends 203 and thus can charge only three external apparatuses simultaneously. However, after the wiring concentration portion 10 has got connected to the power portion 20, the first ports 102 also output power derived from the internal battery 204 of the power portion 20 to thereby charge the external apparatus, and thus six ports 102, 202 charge different external apparatuses simultaneously. At this point in time, the second ports 202 of the power portion 20 function as the first ports 102 extended from the wiring concentration portion 10. Hence, the otherwise self-contained wiring concentration portion 10 has only three first ports 102 and thus can enable only three external apparatuses to exchange data with the host apparatus simultaneously. However, after the wiring concentration portion 10 has got connected to the power portion 20, the second ports 202 also exchange data with the host apparatus, such that the six ports 102, 202 enable different external apparatuses to exchange data with the host apparatus.

In another embodiment, the power portion 20 further comprises a third connection end (not shown) corresponding in structure to the first connection end 103, such that the power portion 20 and another power portion can be connected. Hence, with the wiring concentration portion 10 being connected to the power portion 20, and the power portion 20 being connected to another power portion, two advantages are achieved as follows: the second ports 202 of the power portion 20 function as the first ports 102 extending from the wiring concentration portion 10; and the ports of the other power portion function as the first ports 102 extending from the wiring concentration portion 10. Given the aforesaid series connection, users can series-connect multiple power portions 20 as needed with a view to increasing the quantity of the first ports 102 of the wiring concentration portion 10.

Depending on manufacturer-based configuration or user needs, the first processor 101 has a predetermined power priority sequence. To allow the wiring concentration portion 10 to receive power from the host apparatus, receive the external power supplied by the first external power input end 105, and receive the power supplied by the power portion 20, the first processor 101 chooses one of the powers according the predetermined power priority sequence and supplies the selected power to the external apparatus. For example, in the situation where the predetermined power priority sequence is configured to allow the external power to have the first priority, the power supplied by the power portion 20 to have the second priority, and the power supplied by the host apparatus to have the final priority, to allow the wiring concentration portion 10 to simultaneously receive the three powers, the first processor 101 views choosing the external power as the power source for supplying the external apparatus as a top priority. Like the first processor 101, the second processor 201 of the power portion 20 comes with another predetermined power priority sequence whereby one of the external power received by the second external power input end 205 and the power supplied by the internal battery 204 is chosen and supplied to the external apparatus and/or the wiring concentration portion 10.

Referring to FIG. 2 through FIG. 4, there are shown schematic views of a wiring concentration portion and a power portion which are coupled together according to various embodiments of the present invention.

The wiring concentration portion 10 and the power portion 20 are parallel-connected, series-connected or stacked up, through their connection ends, but the present invention is not limited thereto.

Therefore, the prevent invention provides a wiring concentration apparatus with a removable power source, which enhances ease of use and is characterized in that: a wiring concentration portion and a power portion connect with each other and operate in conjunction with each other; ports of the wiring concentration portion and ports of the power portion are regarded by each other as expansion ports; the ports of the wiring concentration portion enable external apparatuses to be charged; the ports of the power portion enable the external apparatuses to exchange data with a host apparatus; the wiring concentration portion and the power portion are separable from each other, and thus only one of them is carried by a user as needed, thereby achieving enhanced portability.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A wiring concentration apparatus with a removable power source, adapted to effect at least one of charging an external apparatus and exchanging data with a host apparatus, the wiring concentration apparatus comprising:
a wiring concentration portion having a first processor, a plurality of first ports, a first connection end and a host port, wherein the first ports exchange data with the external apparatus connected thereto and exchange data with a host apparatus connected to the host port through the first processor; and
a power portion having a second processor, a plurality of second ports, a second connection end corresponding to the first connection end, and an internal battery, wherein the second ports effectuate a charging process performed on the external apparatus connected to the second ports with a power derived from the internal battery through the second processor,
wherein, when the wiring concentration portion and the power portion are connected through the first connection end and the second connection end, first ports of the wiring concentration portion function as the second ports extended from the power portion, and second ports of the power portion function as the first ports extended from the wiring concentration portion.

2. The wiring concentration apparatus of claim 1, wherein first ports of the wiring concentration portion comprise identical or different ports.

3. The wiring concentration apparatus of claim 2, wherein first ports of the wiring concentration portion has ports complying with a USB type-c protocol.

4. The wiring concentration apparatus of claim 1, wherein second ports of the power portion comprise identical or different ports.

5. The wiring concentration apparatus of claim 4, wherein second ports of the power portion has ports complying with a USB type-c protocol.

6. The wiring concentration apparatus of claim 1, wherein the wiring concentration portion further comprises a first external power input end connected to the first processor to receive an external power and supply the external power to at least one of the external apparatus and the internal battery.

7. The wiring concentration apparatus of claim 6, wherein the first processor of the wiring concentration portion chooses one of a power supplied by the host apparatus, the external power, and a power supplied by the power portion in accordance with a predetermined power priority sequence and supplies the selected power to at least one of the external apparatus and the internal battery.

8. The wiring concentration apparatus of claim 1, wherein the power portion further comprises a second external power input end connected to the second processor to receive the external power and supply the external power to at least one of the external apparatus and the internal battery.

9. The wiring concentration apparatus of claim 6, wherein the second processor of the power portion chooses one of the external power and a power supplied by the internal battery in accordance with a predetermined power priority sequence and supplies the selected power to at least one of the external apparatus and the wiring concentration portion.

10. The wiring concentration apparatus of claim 1, wherein the wiring concentration portion further comprises a first indicating module connected to the first processor to display an operating status of the wiring concentration portion.

11. The wiring concentration apparatus of claim 1, wherein the power portion further comprises a second indicating module connected to the second processor to display an operating status of the power portion.

12. The wiring concentration apparatus of claim 1, wherein the internal battery of the power portion is a rechargeable battery.

13. The wiring concentration apparatus of claim 1, wherein the power portion further comprises a third connection end connected to the second connection end of another power portion.
